(19) United States
(12) Patent Application Publication
(10) Pub. No.: US 2002/0168253 A1
(43) Pub. Date: Nov. 14, 2002

(54) Silage spreader having flow diverter mechanism with swivel vane

(76) Inventor: Kenneth D. Musser, Mount Joy, PA (US)

Correspondence Address: Michael R. Swartz, Esq., 205 Royal Oak Avenue, Pittsburgh, PA, 15235, US

(21) Appl. No.: 09/853,992

(22) Filed: May 11, 2001

(51) Int. Cl. B65G 53/52

(52) U.S. Cl. 414/293; 406/160

(57) ABSTRACT

A silo filling apparatus includes a fill tube for discharging a stream of silage along a flow path into a silo, a silage spreader adapted to undergo movement between operating and non-operating positions for causing and ceasing distribution of silage in the silo, and a flow diverter mechanism having a base and swivel vane rotatably mounted to the base. The base is adapted to undergo movement between retracted and extended positions in which correspondingly the base is displaced from and disposed along the flow path of the silage stream. The swivel vane is disposed in the flow path of the silage stream, when the base is disposed in the extended position, and can undergo rotational movement in opposite directions for selectively diverting silage to one side or the other side of the flow path to level off a top of a silage column.

### BACKGROUND OF THE INVENTION

1. Field of the Invention

The present invention generally relates to silo filling apparatus and, more particularly, is concerned with a silo filling apparatus having a silage spreader and a flow diverter mechanism with a swivel vane.

2. Description of the Prior Art

It has been a common practice for many years to provide a silo filling apparatus which includes a fill tube of generally arcuate or gooseneck configuration disposed at the top of a silo. The fill tube is mounted at its inlet end to an upper end of a blower pipe extending vertically along the exterior of the silo sidewall. The fill tube extends to a discharge end positioned over the top of an interior storage chamber of the silo. Typically, the silo filling apparatus also includes some type of silage spreader supported on and extending outwardly in a cantilevered fashion from the discharge end of the fill pipe. The silage spreader is operable to effect distribution or spreading of silage throughout the interior storage chamber of the silo.

Representative examples of prior art silo filling apparatuses are the ones disclosed in U.S. Pat. No. 2,650,136 to Raleigh, U.S. Pat. No. 3,321,252 to Dreier, U.S. Pat. No. 3,554,610 to Gelle, U.S. Pat. No. 3,570,688 to Ryder et al., U.S. Pat. No. 3,834,768 to Stoltzfus et al., U.S. Pat. No. 4,023,688 to Freeman et al. and U.S. Pat. No. 4,256,419 to Haan. A problem with the use of most prior art silo filling apparatuses arises during finishing of the silo filling process. Such apparatuses through employment of the typical silo fill pipe and silage spreader fail to adequately level off the top of the silage column. This means that an operator has to finish the silo filling process by hand leveling of the silage, such as by holding a scoop shovel in the stream of silage flow to deflect the silage to various locations on the top of the silage column within the interior storage chamber of the silo.

The Freeman et al. patent discloses the provision of an additional spreader plate in an attempt to solve this problem. Once the main silage spreader has been pivoted laterally to a storage position, the additional spreader plate is pivoted down from a non-operative to an operative position where it is stationarily fixed for use in the final portion of the filling cycle. The Freeman et al. spreader plate has a pair of diverging flanges to direct the stream of silage into dual diverging streams thereof to fill top areas of the silage column and thereby somewhat reduce the amount of hand leveling operation that is needed to be performed thereafter. However, the Freeman et al. patent does indicate that even after use of their spreader plate it is still necessary to perform minimal leveling work.

Consequently, a need remains for an innovation in silo filling apparatus which will be sufficiently versatile to eliminate the aforementioned problem without introducing any new problems in place thereof.

### SUMMARY OF THE INVENTION

The present invention provides a silo filling apparatus having a silage spreader and a flow diverter mechanism with a swivel vane which are designed to satisfy the aforementioned need. Instead of having to hold a scoop shovel across the stream of silage flow, the operator can now manually rotate the swivel vane of the flow diverter mechanism in front of the steam of incoming silage flow and from side to side to thereby divert the silage to various regions of the silo to level off the top of the silage column in the silo. The swivel vane provides the necessary versatility in directing the stream of incoming silage to overcome the aforementioned problem of the prior art.

Accordingly, the present invention is directed to a silo filling apparatus which comprises: (a) a fill tube defining an opening for discharging a stream of silage along a flow path into a silo; (b) a silage spreader adapted to undergo movement between operating and non-operating positions for respectively causing and ceasing distribution of silage from the stream thereof about the silo; and (c) a flow diverter mechanism including a base and a swivel vane rotatably mounted to the base. The base is adapted to undergo movement between an retracted inoperative position in which the base is displaced from the flow path of the stream of silage and an extended operative position in which the base is disposed along the flow path of the stream of silage and thus the swivel vane is disposed for use. The swivel vane is disposed in the flow path of the stream of silage when the base is disposed in its extended operative position, after moving the silage spreader to its non-operating position. The swivel vane is adapted to undergo rotational movement relative to the base in opposite directions relative to the flow path of the stream of silage for selectively diverting silage to one side or the other side of the flow path thereof and thereby enable leveling off a top of a column of silage in the silo.

The flow diverter mechanism also includes a pair of mounting ears attached to and extending from the base and having first portions pivotally connected to the fill pipe so as to define a lower transverse pivotal axis about which the base can undergo pivotal movement relative to the fill pipe. The mounting ears further have second portions at which the mounting ears are securable to the fill tube at a location on a side of an upper transverse pivotal axis of the silage spreader that is opposite from the base.

The swivel vane is rotatable about a rotational axis spaced forwardly of the respective upper and lower transverse pivotal axes of the silage spreader and base of the flow diverter mechanism. The flow diverter mechanism further includes a handle fixedly attached to the swivel vane and being movable along an arcuate path to manually rotate the swivel vane about the rotational axis. The base has a pair of rims formed on opposite longitudinal sides of the base which define a plurality of slots for receiving a portion of the handle in a selected one of the slots to retain the handle in a selected angular position along its arcuate path and thereby hold the swivel vane at a selected angular position about its rotational axis and relative to the flow path of the stream of silage.

These and other features and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the following detailed description, reference will be made to the attached drawings in which:

FIG. 1 is a side elevational view of a silo having a silo filling apparatus of the present invention supported at the top of an interior storage chamber of the silo by a top end of a blower pipe extending vertically along the exterior of the silo sidewall.

FIG. 2 is an enlarged side elevational view of the silo filling apparatus with a silage spreader of the apparatus in a lowered operating position and a flow diverter mechanism of the apparatus in a retracted non-operative position.

FIG. 3 is another enlarged side elevational view of the silo filling apparatus similar to that of FIG. 2, but showing the silage spreader in a raised non-operating position and the flow diverter mechanism in an extended operative position.

FIG. 4 is a perspective view of the flow diverter mechanism of the apparatus removed from its pivotal mounting to the fill tube.

FIG. 5 is an end elevational view of the flow diverter mechanism as seen along line 5-5 of FIG. 4, showing a handle of the mechanism in latched and unlatched positions.

FIG. 6 is an enlarged top plan view of the flow diverter mechanism showing a range of angular positions within which a swivel vane of the mechanism can be rotated to divert a stream of silage to one side or the other side of the flow path of the silage stream.

FIG. 7 is a side elevational view of the flow diverter mechanism as seen along line 7-7 of FIG. 6.

FIG. 8 is an exploded fragmentary view of the flow diverter mechanism showing the components for securing the handle of the mechanism to the swivel vane thereof.

### DETAILED DESCRIPTION OF THE INVENTION

In the following description, like reference characters designate like or corresponding parts throughout the several views of the drawings. Also in the following description, it is to be understood that such terms as “forward”, “rearward”, “upwardly”, “downwardly”, and the like are meant to be words of convenience and are not to be construed as limiting terms.

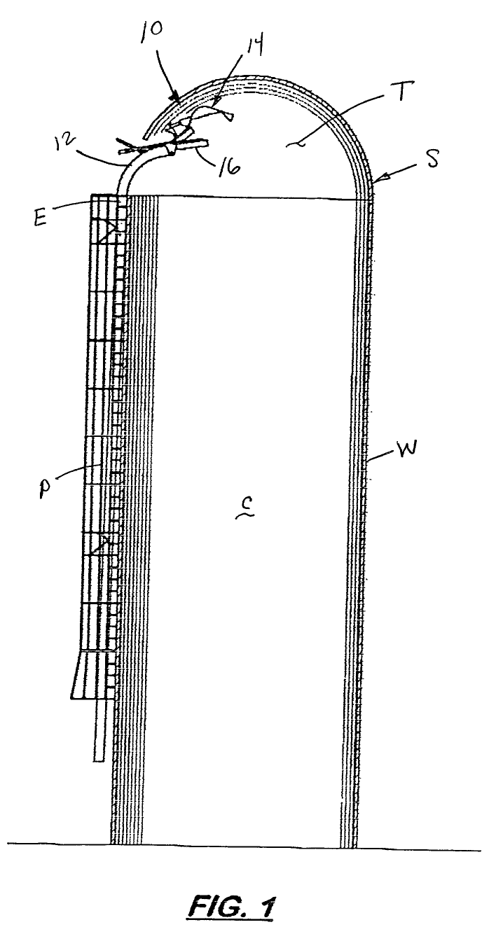

Referring to the drawings and particularly to FIG. 1, there is illustrated a silo filling apparatus, generally designated 10, of the present invention supported at the top T of an interior storage chamber C of a silo S by a top end E of a blower pipe P extending vertically along the exterior of the silo sidewall W. The silo filling apparatus 10 basically includes a fill conduit or tube 12 of arcuate or gooseneck configuration disposed at the top T of the interior storage chamber C of the silo S, a silage distributor or spreader 14 mounted to an upper end portion 12A of the fill tube 12, and a flow diverter mechanism 16 also mounted to the upper end portion 12A of the fill tube 12.

The fill tube 12 of the apparatus 10 has an inlet end 12B mounted to the top end E of the blower pipe P and extending in cantilevered fashion to the upper end portion 12A of the fill tube 12 which defines an outlet end opening 12C positioned above the interior storage chamber C of the silo S. An incoming stream of silage delivered upwardly through the blower pipe P in a known manner is received by the fill tube 12 and discharged from its outlet end opening 12C along a flow path F into the interior storage chamber C of the silo S. The fill tube 12 per se is known in the prior art.

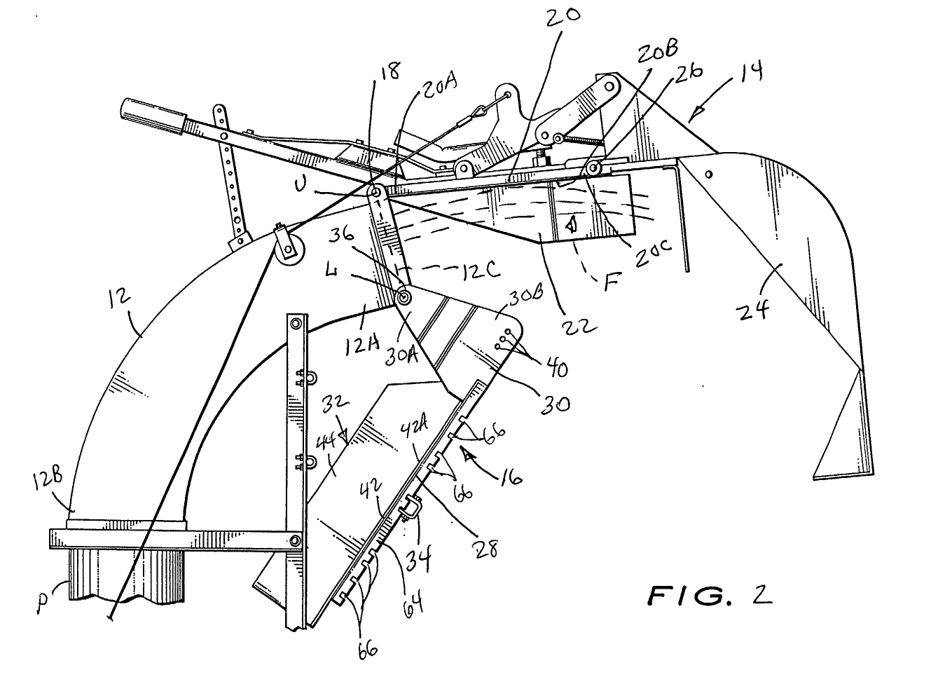

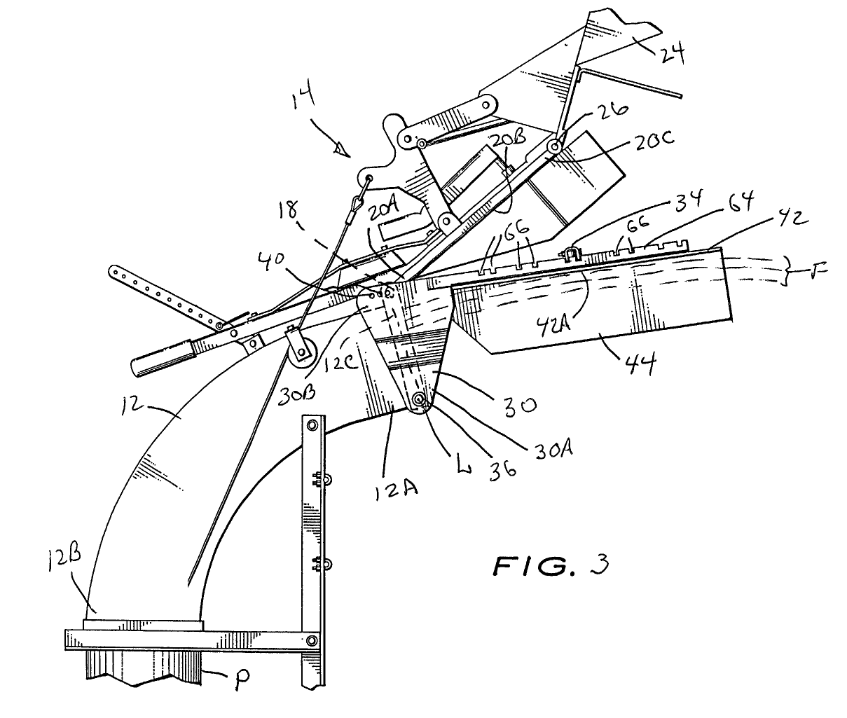

Referring now to FIGS. 2 and 3, the silage spreader 14 of the apparatus 10 is pivotally mounted to the upper end portion 12A of the fill tube 12 by a first pivotal connection 18 for undergoing pivotal movement relative thereto about an upper transverse pivotal axis U defined by the pivotal connection 18 between a lowered operating position, as shown in FIG. 2, and a raised non-operating position, as shown in FIG. 3. In the lowered operating position of FIG. 2, the silage spreader 12 extends along the flow path F of the incoming stream of silage discharging from the fill tube outlet end opening 12C. In the raised non-operating position of FIG. 3, the silage spreader is pivoted about the upper transverse pivotal axis U upwardly from the upper end portion 12A of the fill tube 12 and away from the flow path F of the incoming silage stream.

More particularly, the silage spreader 14 includes an elongated base plate 20 pivotally mounted at a rear end 20A to the upper end portion 12A of the fill tube 12 by the first pivotal connection 18, a first deflector structure 22 fixedly attached along an underside 20B of the base plate 20, and a second deflector structure 24 pivotally mounted by another pivotal connection 26 to a front end 20C of the base plate 20. Multiple streams of silage are produced by the first and second deflector structures 22, 24 of the silage spreader 12 from the one stream of silage discharging from the outlet end opening 12C of the fill tube 12. The multiple streams of silage produced by the silage spreader 12 distributes the silage about the interior storage chamber C of the silo S so as to build a column of silage in the silo S.

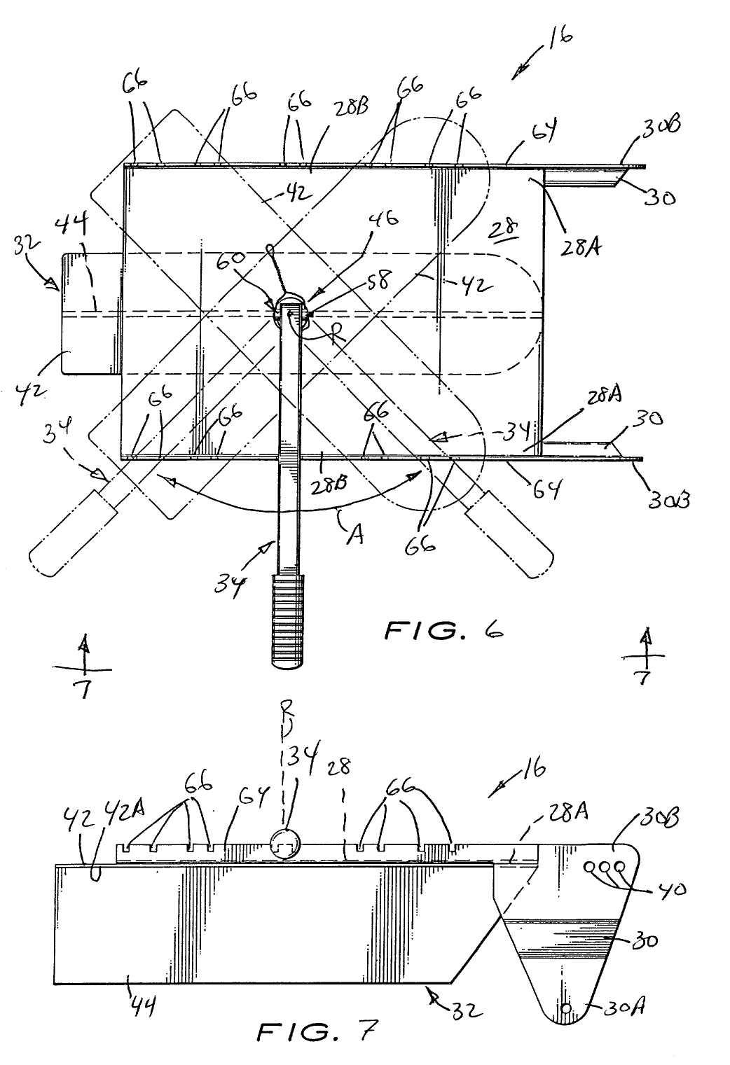

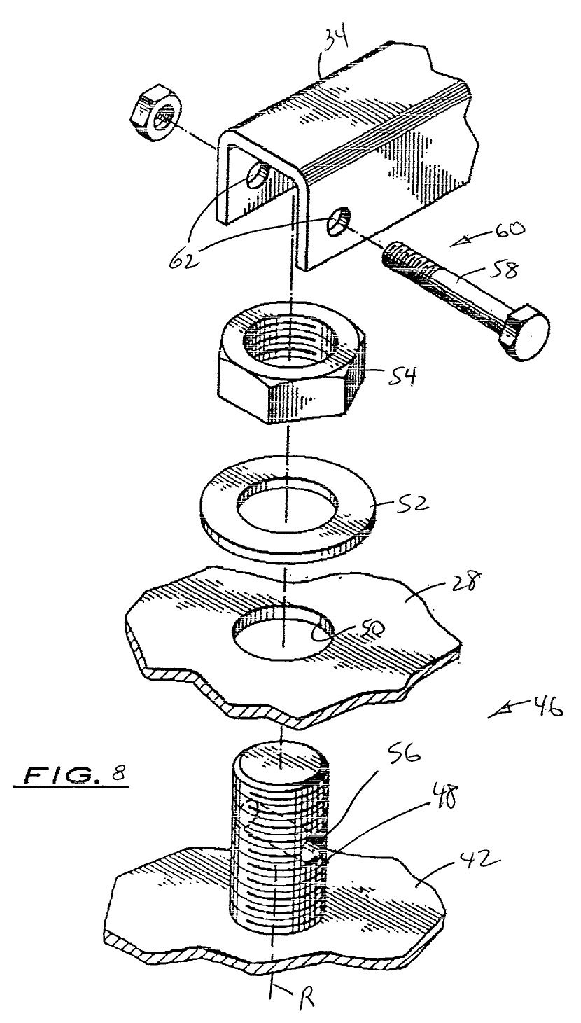

Referring to FIGS. 2-8, the flow diverter mechanism 16 of the apparatus 10 is employed near the end of the silage filling process to level off the top of the silage column. The flow diverter mechanism 16 has a base 28, a pair of mounting ears 30 fixedly attached to and extending from respective rear corner portions 28A of the base 28, a swivel vane 32 rotatably mounted to the base 28, and a handle 34 connected to the swivel vane 32. The base 28 of the flow diverter mechanism 16 preferably, although not necessarily, has a generally flat configuration and is pivotally mounted to the upper end portion 12A of the fill tube 12 by a second pivotal connection 36 for undergoing pivotal movement relative to the fill tube 12 about a lower transverse pivotal axis L that is spaced below and extends substantially parallel to the upper transverse pivotal axis U. The base 28 can be pivotally moved between a retracted inoperative position, as seen in FIG. 2, and an extended operative position, as seen in FIG. 3. In the retracted inoperative position of FIG. 2, the base 28 hangs from the fill tube 12, displaced below and from the flow path F of the stream of silage. In the extended operative position of FIG. 3, the base 28 is disposed along the flow path F of the stream of silage.

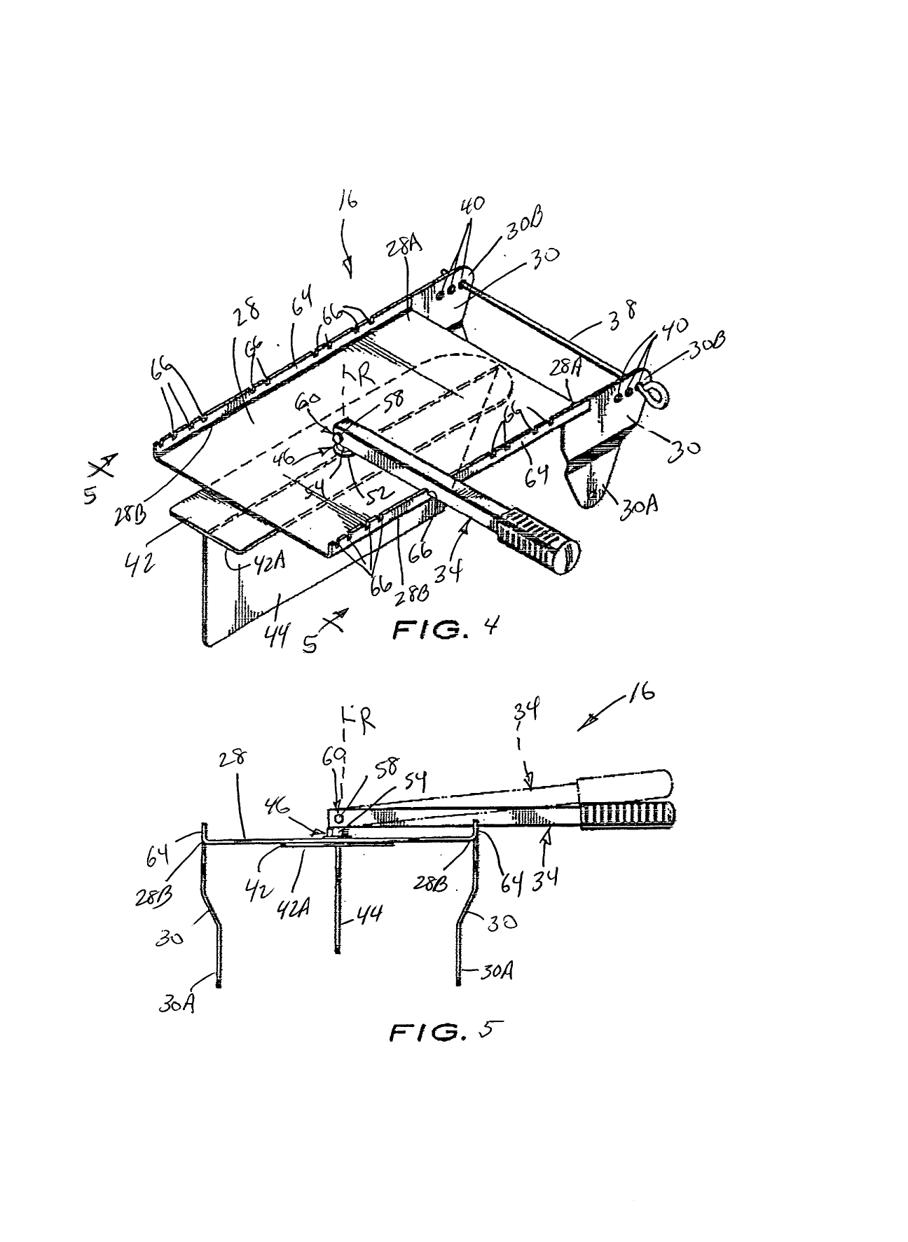

The mounting ears 30 of the flow diverter mechanism 16 are attached to and extend rearwardly from the opposite rear corner portions 28A of the base 28 and are substantially parallel to the opposite sides 28B of the base 28. When the base 28 is disposed in the extended operative position of FIG. 3, the mounting ears 30 extend along opposite sides of the outlet end opening 12C of the upper end portion 12A of the fill tube 12. More particularly, the mounting ears 30 have first portions 30A pivotally connected to the upper end portion 12A of the fill tube 12 by the second pivotal connection 36 so as to define the lower transverse pivotal axis L about which the base 28 can undergo pivotal movement relative to the upper end portion 12A of the fill tube 12. The mounting ears 30 further have second portions 30B at which the mounting ears 30 are securable to the upper end portion 12A of the fill tube 12 by any suitable means, such as by an elongated pin 38 insertable through selected one aligned pair of holes 40 in the second portions 30B of the mounting ears 30 as shown in FIG. 4. The elongated pin 38 does not actually connect with the upper end portion 12A of the fill tube 12 but only abuts it at one side of the first pivotal connection 26 of the silage spreader 14 to the upper end portion 12A of the fill tube 12 which one side is opposite the other side thereof where the base 28 is located, as seen in FIG. 3.

The swivel vane 32 of the flow diverter mechanism 16 is disposed in the flow path of the stream of silage when the base 28 is disposed in the extended position and held there by the elongated pin 38. The swivel vane 32 includes a flat top mounting plate 42 and a silage stream deflector fin or vane element 44 which extends lengthwise of the top mounting plate 42 and is fixed along the longitudinal centerline and on the underside 42A of the top mounting plate 42. The top mounting plate 42 of the swivel vane 32 is rotatably mounted to the base 28 by a connection 46 at substantially central locations on the mounting plate 42 and the base 28 so as to adapt the swivel vane 32 to undergo rotational movement relative thereto about an upright rotational axis R spaced forwardly of the upper and lower transverse pivotal axes U, L of the silage spreader 14 and base 28. As readily seen in FIG. 6, the swivel vane 32 is rotatable in opposite directions relative to the flow path F of the stream of silage for selectively diverting silage to one side to the other side of the flow path F. In such manner, the operation of the swivel vane 32 enables leveling off a top of a column of silage in the silo.

The handle 34 of the flow diverter mechanism 16 is coupled to the swivel vane 32 at the central location thereon by the connection 46 and is movable along an arcuate path A by an operator to manually rotate the swivel vane 32 about the rotational axis R. More particularly, as seen in FIG. 8, the connection 46 includes an externally threaded stud 48 rigidly attached upright at the central location on the top mounting plate 42 of the swivel vane 32, a hole 50 defined at the central location of the base 28 through which the stud 48 extends, an annular washer 52 which fits over the stud 48 and overlies the base 28 about the hole 50 therein, and an internally threaded nut 54 which threads onto the stud 48 and overlies the washer 52. Also, a transverse bore 56 is formed through the stud 48 at a location displaced a sufficient distance above the top mounting plate 42 such that the bore 56 is located above the nut 54 threaded onto the stud 48 and exposed to receive a bolt 58 therethrough for providing a pivotal connection 60 of an end of the handle 34 to the stud 48 to allow pivoting of the handle 34 about an axis B extending generally parallel to the top mounting plate 42 of the swivel vane 32. The pivotal connection 60 does not permit rotation of the handle 34 relative to the swivel vane 32 around the upright rotational axis R of the swivel vane 32 relative to the base 28. With respect to the rotational axis R, the handle 34 rotates thereabout along with the concurrent rotation of the swivel vane 32. The end of the handle 34 has a pair of aligned holes 62 defined therethrough for receiving the bolt 58.

The base 28 has respective rims 64 formed along the opposite longitudinal sides 28B of the base 28. Each rim 64 has a plurality of spaced apart slots 66 defined therein for receiving a portion of the handle 34 in a selected one of the slots 66. When disposed in the selected one of the slots 66, the handle 34 is thereby retained against rotation away from a selected one of many angular positions along its arcuate path A, being shown in FIG. 6, and thereby the swivel vane 32 is held at a selected one of many angular positions about its rotational axis R and relative to the flow path F of the stream of silage. Upon lifting the handle 34 from the one slot 66, the angular positions of the handle 34 and the swivel vane 32 therewith can be changed as desired.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

I claim:

1. A silo filling apparatus, comprising:
(a) a fill tube defining an opening for discharging a stream of silage along a flow path into a silo;
(b) a silage spreader adapted to undergo movement between operating and non-operating positions for respectively causing and ceasing distribution of silage from the stream thereof about the silo; and
(c) a flow diverter mechanism including a base and a swivel vane rotatably mounted to said base, said base being adapted to undergo movement between a retracted inoperative position in which said base is displaced from the flow path of the stream of silage and an extended operative position in which said base is disposed along the flow path of the stream of silage and thus the swivel vane is disposed for use, said swivel vane being disposed in the flow path of the stream of silage, when said base is disposed in said extended operative position, and adapted to undergo rotational movement relative to said base in opposite directions relative to the flow path of the stream of silage for selectively diverting silage to one side or the other side of the flow path thereof and thereby enable leveling off a top of a column of silage in the silo.

2. The apparatus as recited in claim 1, wherein said silage spreader in said operating position extends into the flow path of the stream of silage.

3. The apparatus as recited in claim 1, wherein said silage spreader in said non-operating position is displaced away from the flow path of the stream of silage.

4. The apparatus as recited in claim 3, wherein said base of said flow diverter mechanism is adapted to undergo movement relative to said silage spreader when said silage spreader is disposed at said non-operating position.

5. The apparatus as recited in claim 1, wherein said silage spreader is mounted to said fill tube adjacent to said opening thereof for undergoing pivotal movement relative to said fill tube about an upper transverse pivotal axis between said operating and non-operating positions wherein said silage spreader in said non-operating position is disposed about said upper transverse pivotal axis upwardly from said opening of said fill tube.

6. The apparatus as recited in claim 5, wherein said base of said flow diverter mechanism is mounted to said fill tube adjacent to said opening thereof for undergoing pivotal movement relative to said fill tube about a lower transverse pivotal axis spaced below and extending substantially parallel to said upper transverse pivotal axis of said silage spreader.

7. The apparatus as recited in claim 6, wherein said flow diverter mechanism also includes a pair of mounting ears attached to and extending from said base and having first portions pivotally connect to said fill tube so as to define said lower transverse pivotal axis about which said base can undergo pivotal movement relative to said fill tube.

8. The apparatus as recited in claim 7, wherein said mounting ears further have second portions at which said mounting ears are securable to said fill tube adjacent to and alongside said opening thereof at a location on a side of said upper transverse pivotal axis of said silage spreader that is opposite from said base.

9. The apparatus as recited in claim 6, wherein said swivel vane is rotatable about a rotational axis spaced forwardly of said respective upper and lower transverse pivotal axes of said silage spreader and said base of said flow diverter mechanism.

10. The apparatus as recited in claim 1, wherein said base of said flow diverter mechanism is mounted to said fill tube adjacent to said opening thereof for undergoing pivotal movement relative to said fill tube about a transverse pivotal axis.

11. The apparatus as recited in claim 10, wherein said swivel vane of said flow diverter mechanism is rotatable about a rotational axis spaced forwardly of said transverse pivotal axis of said base.

12. The apparatus as recited in claim 1, wherein said flow diverter mechanism further includes a handle connected to said swivel vane and being movable along an arcuate path to manually rotate said swivel vane about said rotational axis.

13. The apparatus as recited in claim 12, wherein said base has means for defining a plurality of slots for receiving a portion of said handle in a selected one of said slots to retain said handle in a selected angular position along said arcuate path and thereby hold said swivel vane at a selected angular position about said rotational axis and relative to the flow path of the stream of silage.

14. The apparatus as recited in claim 13, wherein said slot defining means for receiving said portion of said handle is a pair of rims each formed along one of a pair of opposite longitudinal sides of said base.

15. A silo filling apparatus, comprising:
(a) a fill tube having an upper end portion disposable above an interior storage chamber of a silo for discharging an incoming stream of silage along a flow path into the interior storage chamber of the silo;
(b) a silage spreader mounted to said upper end portion of said fill tube for undergoing pivotal movement relative to said fill tube about an upper transverse pivotal axis between a lowered operating position wherein said silage spreader extends along the flow path of the incoming stream of silage discharging from said fill tube and a raised non-operating position wherein said silage spreader is pivoted about said upper transverse pivotal axis upwardly from said upper end portion of said fill tube and away from the flow path of the incoming stream of silage; and
(c) a flow diverter mechanism having a base and a swivel vane rotatably mounted to said base, said base being mounted to said upper end portion of said fill tube for undergoing pivotal movement relative to said fill tube about a lower transverse pivotal axis spaced below and substantially parallel to said upper transverse pivotal axis and between a retracted inoperative position in which said base is displaced from the flow path of the stream of silage and an extended operative position in which said base is disposed along the flow path of the stream of silage and thus said swivel vane is disposed for use, said swivel vane being disposed in the flow path of the stream of silage, when said base is disposed in said extended operative position, and adapted to undergo rotational movement about an upright rotational axis relative to said base and in opposite directions relative to the flow path of the stream of silage for selectively diverting silage to one side or the other side of the flow path thereof and thereby enable leveling off a top of a column of silage in the silo.

16. The apparatus as recited in claim 15, wherein said flow diverter mechanism also includes a pair of mounting ears attached to and extending from said base and having first portions pivotally connect to said fill tube so as to define said lower transverse pivotal axis about which said base can undergo pivotal movement relative to said fill tube.

17. The apparatus as recited in claim 16, wherein said mounting ears further have second portions at which said mounting ears are securable to said upper end portion of said fill tube at a location on a side of said upper transverse pivotal axis of said silage spreader that is opposite from said base.

18. The apparatus as recited in claim 15, wherein said flow diverter mechanism further includes a handle connected to said swivel vane and being movable along an arcuate path to manually rotate said swivel vane about said rotational axis.

19. The apparatus as recited in claim 18, wherein said base has means for defining a plurality of slots for receiving a portion of said handle in a selected one of said slots to retain said handle in a selected angular position along said arcuate path and thereby hold said swivel vane at a selected angular position about said rotational axis and relative to the flow path of the stream of silage.

20. The apparatus as recited in claim 19, wherein said slot defining means for receiving said portion of said handle is a pair of rims each formed along one of a pair of opposite longitudinal sides of said base.

21. A flow diverter mechanism for use in filling a silo having a fill tube defining an opening for discharging a stream of silage along a flow path into the silo, said flow diverter mechanism comprising:
(a) a base adapted to undergo movement between a retracted inoperative position in which said base is displaced from the flow path of the stream of silage and an extended operative position in which said base is disposed along the flow path of the stream of silage; and
(b) a swivel vane rotatably mounted to said base, said swivel vane being disposed in the flow path of the stream of silage, when said base is disposed in said extended operative position, and adapted to undergo rotational movement relative to said base in opposite directions relative to the flow path of the stream of silage for selectively diverting silage to one side or the other side of the flow path thereof and thereby enable leveling off a top of a column of silage in the silo.

22. The mechanism as recited in claim 21, wherein said flow diverter mechanism further includes a pair of mounting ears attached to and extending from said base and having portions pivotally connected to the fill tube of the silo so as to define a pivotal axis about which said base can undergo pivotal movement relative to said fill tube.

23. The mechanism as recited in claim 21, wherein said base of said flow diverter mechanism is mounted to the fill tube of the silo adjacent to said opening thereof for undergoing pivotal movement relative to said fill tube about a transverse pivotal axis.

24. The mechanism as recited in claim 23, wherein said swivel vane of said flow diverter mechanism is rotatable about a rotational axis spaced forwardly of said transverse pivotal axis of said base.

25. The mechanism as recited in claim 24, wherein said flow diverter mechanism further includes a handle connected to said swivel vane and being movable along an arcuate path to manually rotate said swivel vane about said rotational axis.

26. The mechanism as recited in claim 25, wherein said base has means for defining a plurality of slots for receiving a portion of said handle in a selected one of said slots to retain said handle in a selected angular position along said arcuate path and thereby hold said swivel vane at a selected angular position about said rotational axis and relative to the flow path of the stream of silage.

27. The mechanism as recited in claim 26, wherein said slot defining means for receiving said portion of said handle is a pair of rims each formed along one of a pair of opposite longitudinal sides of said base.

28. The mechanism as recited in claim 21, wherein said swivel vane includes a flat top mounting plate and a silage stream deflector fin which extends lengthwise of said top mounting plate and is fixed along the longitudinal centerline and on the underside of said top mounting plate.

29. The mechanism as recited in claim 28, wherein said top mounting plate is rotatably mounted to said base by a connection at substantially central locations on said mounting plate and said base so as to adapt said swivel vane to undergo rotational movement relative thereto about an upright rotational axis.
